(19) United States
(12) Patent Application Publication
(10) Pub. No.: US 2025/0218001 A1
(43) Pub. Date: Jul. 3, 2025

(54) METHODS FOR MOTION ARTIFACT REDUCTION AND CORRECTION OF MULTISPECTRAL SOFT TISSUE IMAGING AND RELATED SYSTEMS

(71) Applicant: East Carolina University, Greenville, NC (US)

(72) Inventors: Cheng Chen, Greenville, NC (US); Joffre Alvarez, Winterville, NC (US); Elizabeth Clarke, Greenville, NC (US); Megan Rosengarten, Weston, CT (US); Phil Hodges, Williamston, NC (US)

(21) Appl. No.: 19/008,829

(22) Filed: Jan. 3, 2025

Related U.S. Application Data
(60) Provisional application No. 63/617,166, filed on Jan. 3, 2024.

(51) Int. Cl. G06T 7/215

(52) U.S. Cl. CPC G06T 7/215; G06T 2207/10036

(57) ABSTRACT

Various motion artifact reduction and correction methods are provided within multispectral soft tissue imaging architecture. A motion amplitude indication and monitoring strategy is useful before reducing motion and this can be achieved through hardware sensors such as accelerometers, gyroscopes, or software analysis such as image registration, optics flow. Large and medium level motion such as device shaking, and target breathing can be resolved through image stabilization and snapshot approach by only using a time interval where motion is minimum. Small and micro motion such as device vibration can be resolved through motion correction by identifying the mathematical correlation between velocity magnitude and signal to noise ratio (SNR) or baseline normalization by using a standard reflection marker. Sources of the motion need to be taken into consideration such as intrinsic motion from the target or extrinsic motion from the device. The present inventive concept can apply to broadband, narrowband, fluorescence, autofluorescence, Laser Speckle Imaging (LSI), Laser Doppler Imaging (LDI), tissue oxygenation imaging, and other variation of soft tissue imaging modalities. The imaging software includes temporally and spatially synchronized acquisition of motion amplitude, multiple imaging channels, image processing based on physics principle and mathematical equations of each imaging modality, motion reduction and correction, image fusion-based visualization and report. The system is designed to be an addon to smart phones, tablets, and other mobile devices as portable equipment.

### CLAIM OF PRIORITY

The present application claims priority to and the benefit of U.S. Provisional Application No. 63/617,166, filed on Jan. 3, 2024 entitled Methods for Motion Artifact Reduction and Correction of Multispectral Soft Tissue Imaging, the content of which is hereby incorporated by reference as if set forth in its entirety.

### FIELD

The present inventive concept relates to identifying and measuring the magnitude of a motion artifact in multispectral soft tissue imaging modalities, such Laser Speckle Imaging (LSI), Laser Doppler Imaging (LDI), Saturation of Peripheral Oxygen (SpO₂) and mitigating the motion impact on image quality, accuracy of the quantification result and overall usability in clinical applications such as wound or burn assessment using a handheld device.

### BACKGROUND

Laser Speckle Imaging (LSI) is a valuable technique for real time mapping and assessment of blood flow and perfusion, but there is a practical need to make the quantification robust again motion artifacts. The measurement results of blood flow and perfusion imaging technologies are typically disrupted by a motion artifact of the target tissue and/or imaging equipment in clinical circumstances. This magnitude of movement can be small (e.g., pulsatility of an arteriole due to systole and diastole blood pressure levels), intermediate (e.g., normal peristalsis of the small or large bowel) or large (e.g., target motion during breathing or ventilation). This movement can be intrinsic to the imaged target (examples above), or extrinsic movement (camera shaking). Thus, in many clinical situations, where accurate quantification of flow and perfusion is desirable, keeping the imaging target stationery is difficult and, in some clinical scenarios, is not even possible. Unfortunately, most conventional laser-based perfusion technologies either assume the target tissue/organ is stationary, which introduces significant inaccuracy or error in the clinical measurement of blood flow speed where the target is moving or simply provide no information for quantification of perfusion in terms of blood flow rate distribution that is critically needed in the clinical situation.

Furthermore, if a soft tissue imaging modality requires processing a sequence of frames and/or a neighborhood of pixels in multiple frames, its result will be potentially affected by motion artifact causing blurry image and inaccurate calculation. Examples are LSI, Laser Doppler Imaging (LDI), and peripheral arterial oxygen saturation imaging (SpO₂). There are two sources of motion: target movement (e.g., caused by respiration) and device movement (e.g., caused by vibration). Technically mature solutions such as image stabilization (either through hardware or software) can only handle translational camera movement and display aligned visible images under non-coherent illumination. The motion noise in laser speckle contrast can be at subpixel level which means there is still motion artifact even if one frame is aligned with the next one at pixel-to-pixel accuracy.

### SUMMARY

Some embodiments of the present inventive concept provide various motion artifact reduction and correction methods within multispectral soft tissue imaging architecture. A motion amplitude indication and monitoring strategy is useful before reducing motion and this can be achieved through hardware sensors such as accelerometers, gyroscopes, or software analysis such as image registration, and optics flow. Large and medium level motion such as device shaking, and target breathing can be resolved through image stabilization and snapshot approach by only using a time interval where motion is minimum. Small and micro motion such as device vibration can be resolved through motion correction by identifying the mathematical correlation between velocity magnitude and signal to noise ratio (SNR) or baseline normalization by using a standard reflection marker. Sources of the motion need to be taken into consideration such as intrinsic motion from the target or extrinsic motion from the device. The present inventive concept applies to broadband, narrowband, fluorescence, autofluorescence, Laser Speckle Imaging (LSI), Laser Doppler Imaging (LDI), tissue oxygenation imaging, and other variation of soft tissue imaging modalities. The imaging software includes temporally and spatially synchronized acquisition of motion amplitude, multiple imaging channels, image processing based on physics principle and mathematical equations of each imaging modality, motion reduction and correction, image fusion-based visualization and report. The system is designed to be an addon to smart phones, tablets, and other mobile devices as portable equipment.

### BRIEF DESCRIPTION OF THE DRAWINGS

FIGS. 1A through 1C illustrate a visible color image, perfusion distribution of a human palm and tracking average pixel shift between displayed frames during a 10-second video, respectively, while fingers continuously move in accordance with some embodiments of the present inventive concept.

FIGS. 2A through 2C illustrate a visible color image, perfusion distribution of an in vivo porcine large intestine and tracking average pixel shift between displayed frames during a 10-second video, respectively, while the target is under respiratory motion in accordance with some embodiments of the present inventive concept.

FIGS. 3A through 3C illustrate a visible color image, perfusion distribution of an in vivo porcine small intestine and tracking average pixel shift between displayed frames during a 10-second video, respectively, while the target is under respiratory motion in accordance with some embodiments of the present inventive concept.

FIGS. 4A through 4C illustrate a visible color image, perfusion distribution of a human palm and tracking average pixel shift between displayed frames during a 10-second video, respectively, while imaging device continuously vibrate in accordance with some embodiments of the present inventive concept.

FIG. 5 is a chart illustrating a motion artifact mitigation strategy in three steps in accordance with some embodiments of the present inventive concept.

FIGS. 6A through 6D illustrates a visible color image, perfusion distribution of an in vivo porcine small intestine and tracking average image intensity variation and pixel shift between displayed frames during a 10-second video, respectively, while the target is under respiratory motion in accordance with some embodiments of the present inventive concept.

FIGS. 7A through 7C illustrate a tracking average pixel shift between displayed frames during a 10-second video of an in vivo porcine large intestine while the target is under respiratory motion and identifying a small-time window where motion artifact is minimum to generate visible color image and perfusion distribution in accordance with some embodiments of the present inventive concept.

FIGS. 8A through 8C illustrate tracking average pixel shift between displayed frames during a 10-second video of a human palm while fingers continuously move and identifying a small-time window where motion artifact is minimum to generate visible color image and perfusion distribution in accordance with some embodiments of the present inventive concept.

FIGS. 9A through 9C illustrate tracking average pixel shift between displayed frames during a 10-second video of an in vivo porcine small intestine while target is under respiratory motion and identifying a small-time window where motion artifact is minimum to generate visible color image and perfusion distribution in accordance with some embodiments of the present inventive concept.

FIGS. 10A and 10B are graphs illustrating a strategy to achieve step 3 of FIG. 5. FIG. 10A is a graph illustrating mathematical correlation between average pixel shift and percentage motion noise in calculated perfusion index of a 20-second multispectral video of a human palm when device starts vibrating at the beginning of the video and stops vibrating toward the end of video in accordance with some embodiments of the present inventive concept(s). FIG. 10B is a graph illustrating perfusion index curve over time before motion correction (dotted line) and after motion correction (thin line) in accordance with some embodiments of the present inventive concept.

FIGS. 11A through 11D illustrates the result of step 3 of FIG. 5. FIGS. 11A and 11B illustrate a visible color image, perfusion distribution of a human palm before motion correction in accordance with some embodiments of the present inventive concept. FIG. 11B illustrates a visible color image, perfusion distribution of a human palm after motion correction in accordance with some embodiments of the present inventive concept.

FIG. 12 is a chart illustrating a real time strategy to achieve steps 1 and 2 of FIG. 5 to avoid large motion (FIG. 5 step 1) and reduce blurriness (FIG. 5 step 2) caused by medium motion in accordance with some embodiments of the present inventive concept.

FIG. 13 is a chart illustrating a real time strategy to achieve step 2-1 of FIG. 12 in detail to synchronize images of visible, NIR cameras and data from motion sensor in multiple predefined buffer loops in accordance with some embodiments of the present inventive concept.

FIG. 14 is a graph illustrating synchronization result of images of visible, NIR cameras and data from motion sensor around index i of visible frame (middle box in FIG. 13) in accordance with some embodiments of the present inventive concept.

FIG. 15 is a chart illustrating a real time strategy to achieve step 2-2 of FIG. 12 in detail to read and analyze sensor data from the sensor buffer loop in accordance with some embodiments of the present inventive concept.

FIG. 16 is a plot illustrating the result of motion threshold examination in step 2.2 of FIG. 12 in accordance with some embodiments of the present inventive concept.

FIG. 17 is a chart illustrating a real time strategy to achieve step 2-3 of FIG. 12 in detail to read NIR images that are temporally synchronized with motion sensor data from NIR camera buffer loop in accordance with some embodiments of the present inventive concept.

FIG. 18 is a chart illustrating a real time strategy to achieve step 2-4 of FIG. 12 in detail to calculate a sequence of laser speckle contrast images and further generate a laser speckle contrast snapshot in accordance with some embodiments of the present inventive concept.

FIG. 19 is a chart illustrating a real time strategy to achieve step 2-5 and 2-6 of FIG. 12 in detail to read a visible image that is temporally aligned in the middle of multiple NIR images and calculate a composite MSPV tensor in accordance with some embodiments of the present inventive concept.

FIG. 20 includes multiple images illustrating the content of the composite MSPV sensor in FIG. 19 in accordance with some embodiments of the present inventive concept.

FIGS. 21A and 21B are plots illustrating motion amplitude measured by gyroscope as degree/second when imaging device is held by operator stably (21A) and unstably (21B) in accordance with some embodiments of the present inventive concept.

FIG. 22 is a high level block diagram of a data processing system used in combination with embodiments of the present inventive concept.

### DETAILED DESCRIPTION OF EMBODIMENTS

Embodiments of the present inventive concept will now be described more fully hereinafter with reference to the accompanying figures, in which some embodiments of the inventive concept are shown. This inventive concept may, however, be embodied in many different forms and should not be construed as limited to the embodiments set forth herein. Like numbers refer to like elements throughout. In the figures, layers, regions, elements or components may be exaggerated for clarity. Broken lines illustrate optional features or operations unless specified otherwise.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the inventive concept. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

As will be appreciated by one of skill in the art, embodiments of the present inventive concept may be embodied as a method, system, data processing system, or computer program product. Accordingly, the present inventive concept may take the form of an embodiment combining software and hardware aspects, all generally referred to herein as a “circuit” or “module.” Furthermore, the present inventive concept may take the form of a computer program product on a non-transitory computer usable storage medium having computer usable program code embodied in the medium. Any suitable computer readable medium may be utilized including hard disks, CD ROMs, optical storage devices, or other electronic storage devices.

Computer program code for carrying out operations of the present inventive concept may be written in an object-oriented programming language such as Matlab, Mathematica, Python, Java, Smalltalk, C or C++. However, the computer program code for carrying out operations of the present inventive concept may also be written in conventional procedural programming languages, such as the “C” programming language or in a visually oriented programming environment, such as Visual Basic.

Certain program codes may execute entirely on one or more of a user's computer, partly on the user's computer, as a standalone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The inventive concept is described in part below with reference to flowchart illustrations and/or block diagrams of methods, devices, systems, computer program products and data and/or system architecture structures according to embodiments of the inventive concept. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer readable memory or storage that can direct a computer or other programmable data processing apparatus to function in a particular manner, such that the instructions stored in the computer-readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

As used herein, “real time” refers processing input data within, for example, milliseconds so that it is available virtually immediately as feedback.

Some embodiments of the present inventive concept indicate, analyze and monitor motion artifacts during multispectral soft tissue imaging process and mitigate the impact of motion artifacts on image quality, quantification accuracy and usability of handheld devices.

Multispectral imaging design includes a light source emitting multiple bands of wavelength using free space optics, or fiber optics coupling with light source such as lasers, light emitting diodes (LEDs) etc. Each band of wavelength can be coherent, or non-coherent depending on the optical physics principle of the specific imaging modality. Other optics characters of each band of wavelength such as power, pulsing, and irradiance/flux can be adjusted depending on the imaging application.

Multispectral imaging design also includes sensors detecting each band of wavelength of reflected light or emission light of fluorescence and autofluorescence. The designs can include multiple-camera, multi-sensor or single sensor with multispectral pixels or single sensor to detect each band of wavelength at a different time. The spectral regions of illumination and detection include ultraviolet (UV) (100-400 nm), Visible (400-700 nm), and near infrared (NIR) (700-1000 nm).

Multispectral imaging design can include both anatomical and functional imaging modalities in a medical device such as broadband, narrowband, fluorescence, autofluorescence, Laser Speckle Imaging (LSI), Laser Doppler Imaging (LDI), tissue oxygenation imaging, and other variations of soft tissue imagers.

Some embodiments of the present inventive concept provide methods to quantify the magnitude of motion artifact using image intensity variation or pixel location variation between frames by analyzing one or multiple channels of images. Using motion indicator, image acquisition can be avoided when large target or device motion artifacts occur as velocity magnitude is above certain threshold.

Some embodiments of the present inventive concept provide options to stabilize device motion using a gimbal motor to mount the camera, or floating lens technique. Target motion can be stabilized using software algorithms such as image registration, optical flow to align key frames before image processing procedure. If the snapshot output is acceptable, a small-time window can be selected among the entire recorded video where the motion artifact is minimized by examining the motion magnitude. Motion artifacts with medium and small magnitudes can be reduced by processing images within that time frame or selecting frames when the motion magnitude is under certain threshold.

Some embodiments of the present inventive concept provide methods to correct micro sub pixel motion artifact by estimating the mathematical correlation between motion component among signal or signal to noise ratio (SNR) and pixel shift if translational device motion is the major source of noise. The calculation result can be renormalized based on this mathematical correlation that is estimated during device calibration.

Some embodiments of the present inventive concept provide methods to use a standard reflection marker in the field of view (FOV) and serve as normalization reference. A diffuse reflection marker can simulate the static component of scattering reflection of a biological tissue and its imaging result correlates with motion artifact as a baseline. By renormalizing the imaging result of perfusion or oxygen calculation using a baseline marker, the micro motion artifact can be corrected.

Form factors of soft tissue imagers include handheld devices, tablet devices, and detachable devices from medical towers, robots, and cart devices with extension arms. Motion artifact mitigation is generally critical for multispectral soft tissue imaging especially when the device is designed as an add on to smart phones, tablets, and other mobile devices including illumination, sensing, and control units. The mobile devices are used to provide computational, display, storage, internet access units and possibly visible illumination and sensing units.

Human organs are composed of different types of soft and hard tissues. The soft tissues have complex structures and compositions. As the largest organ of the human body, for example, skin possesses a layered structure of multiple tissues that include epidermis, dermis and hypodermis. The skin dermis consists of connective tissues, blood, endothelium and subendothelial connective tissues of blood vessels, fat, etc. Current wound triage is first done visually by the health care professional or emergency worker. Studies have shown that this initial visual assessment is roughly 50% accurate for frontline and emergency workers and 70% accurate for wound and burn specialists. Utilizing this technology in accordance with embodiments discussed herein will enhance this accuracy in every healthcare setting, from treatment of chronic wounds in Diabetics to assessment of blast injuries on the battlefield.

Multispectral technology utilizes illumination beyond the visible band, such as UV (300-400 nm) and NIR (700-1000 nm) to gain new information not only of the anatomical structure of the tissue but functional characteristics of the tissue physiology. Multispectral technology synchronizes all imaging channels temporally (alignment of time stamps) and spatially (alignment of pixels) and broaden multispectral platform by combining a wide range of illuminations and camera sensors to achieve this synchronization purpose. It also adds various imaging modalities on the multispectral platform and each modality generates its own featured imaging result different than the raw images, such as blood flow and perfusion, oxygenation, and fluorescence maps. However, the blood flow and perfusion imaging can be negatively affected by a motion artifact of the target tissue/organ and/or the device in clinical circumstances causing blurry and distorted images, and false positive results.

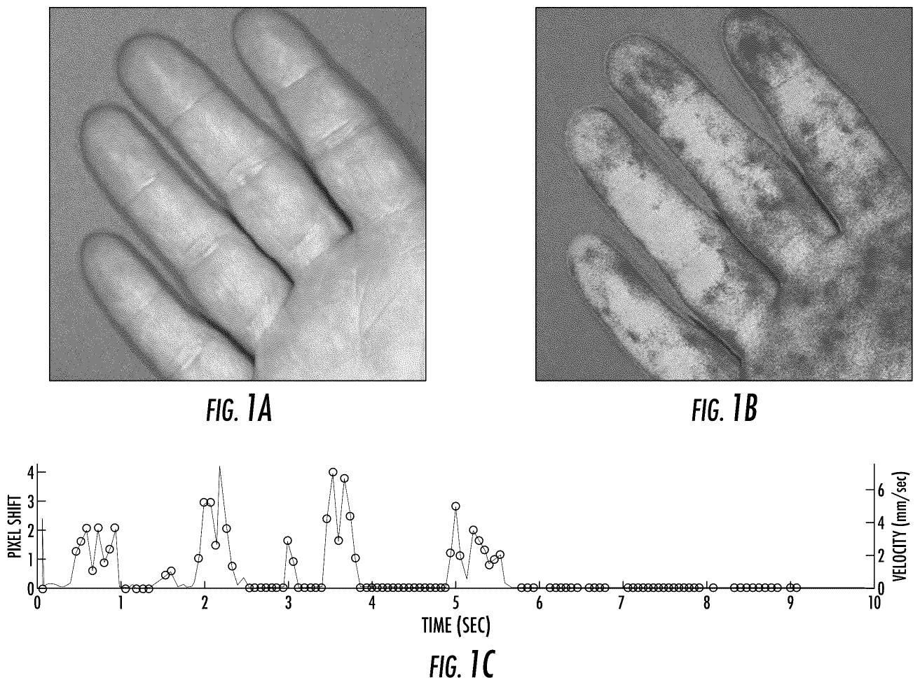

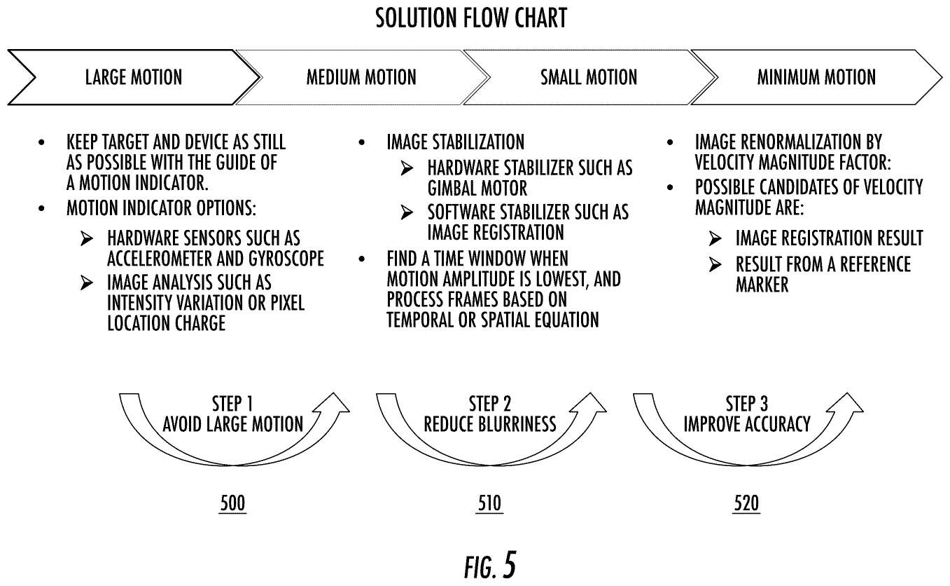

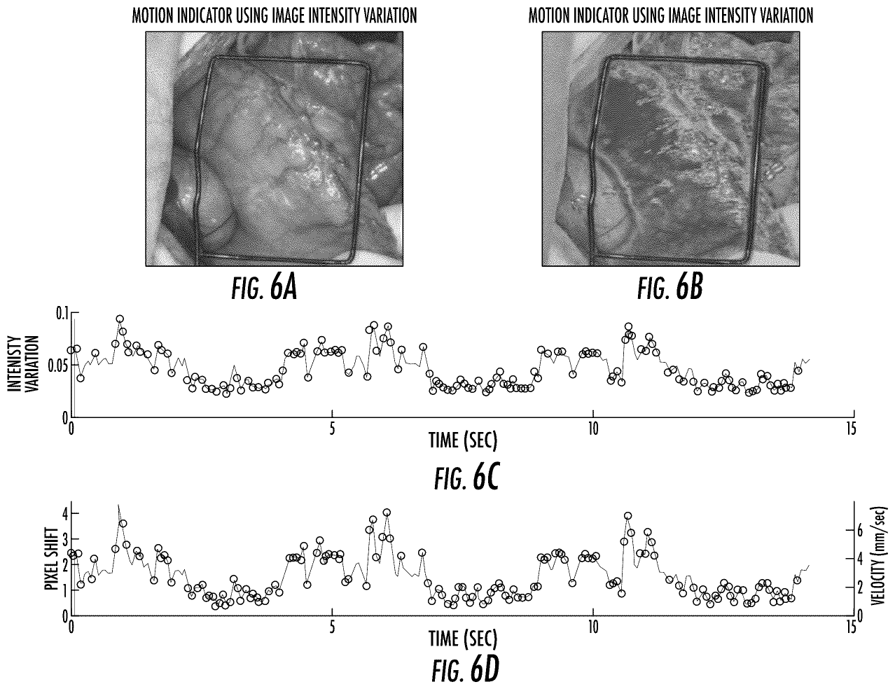

In clinical settings, a motion artifact can be caused by, for example, the following sources: voluntary movement of the target, target breathing or ventilation effect, normal peristalsis of the small or large bowel, device movement while being held by user, such as shaking. In some embodiments of the present inventive concept, a three-step motion mitigation design approach is described based on identifying and quantifying motion magnitude or velocity through image intensity variance and pixel shift between image frames. A time series signal to indicate motion magnitude is calculated based on hardware sensor or image registration or optics flow algorithms to guide each motion artifact mitigation step. The goal is to generate a blood flow and perfusion map or tissue oxygenation map that can be reliably compared at different stages of wound treatment and healing process. FIGS. 1A-4C illustrate images created using a few motion sources and magnitude over time. FIG. 5 is a flowchart illustrating an overall motion artifact mitigation strategy. FIGS. 6A-11D illustrate detailed examples of each step of the motion artifact mitigation process in accordance with embodiments discussed herein.

Referring first to FIGS. 1A-C, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. As illustrated, the target is a human palm with normal blood flow and perfusion and the fingers were moving during the image acquisition process to simulate voluntary target motion artifact. FIGS. 1A and 1B illustrates a first output frame showing a temporal and spatially synchronized and aligned visible color image (1A) and blood flow and perfusion map (1B) based on laser speckle contrast analysis. The motion artifact is evaluated and indicated by average pixel shift between frames and converted into velocity unit (mm/sec) using imaging parameters such as size of field of view (FOV) and resolution through Eqn. 1.

$$v ( i , j ) = \frac{pixel shift ( i , j ) \times pixel size}{1 / FPS} \qquad ( Eqn . 1 )$$

where v is the speed of target or tissue motion at pixel index i, j between frames; and frames per second (FPS) is the frame rate. The average pixel shift can be calculated using visible or NIR images through image registration algorithm or optics flow algorithm. As is clear from the FIG. 1C, when the hand is stationary the pixel shift is close to zero and when fingers are moving pixel shift dramatically increases to 3-4 pixels between frames with speed around 6 mm/second. This example demonstrates that pixel shift can be an effective motion artifact indictor.

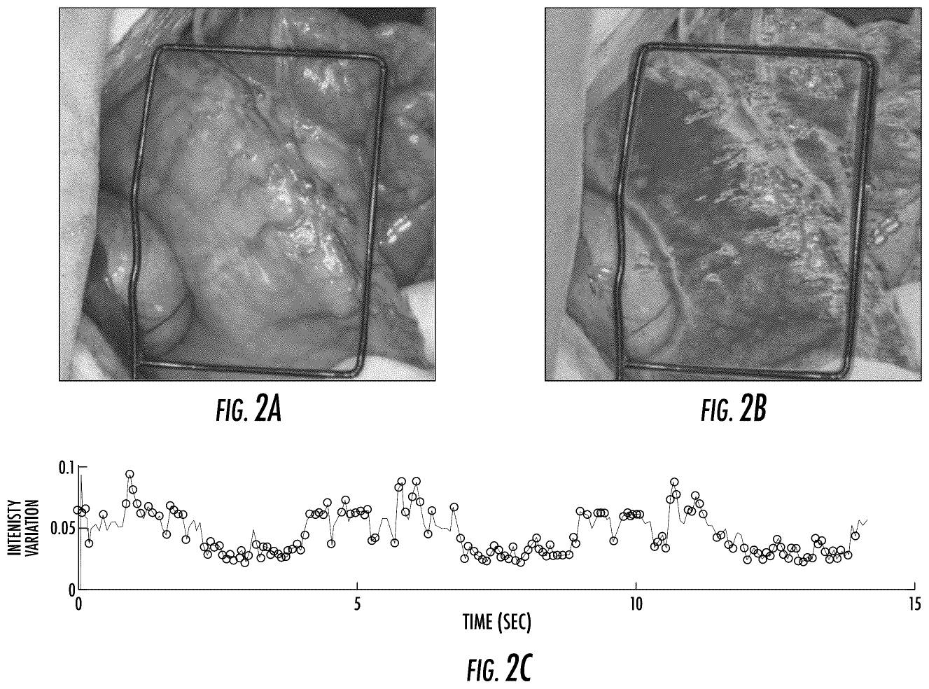

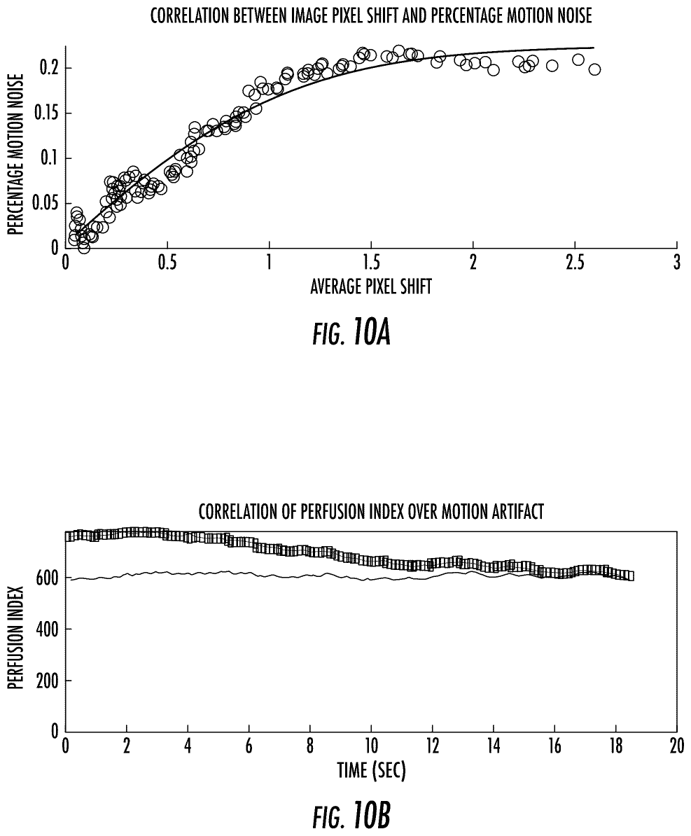

Referring now to FIGS. 2A through 2C, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a segment of porcine intestine with normal blood flow and perfusion and the target continuously moves due to result of ventilation during the image acquisition process. FIGS. 2A and 2B are snapshots of the first frame illustrating temporal and spatially synchronized and aligned visible color image (2A) and blood flow and perfusion map (2B) based on laser speckle contrast. The motion artifact is evaluated and indicated by average image intensity variation between frames of the visible channel. The average image intensity variation can be calculated using Eqn. 2 of visible or NIR images.

$${K}_{i} = {Σ}_{k}^{N y} {Σ}_{j = 1}^{N x} {σ}_{i , j , k} / {μ}_{i , j , k} \qquad ( Eqn . 2 )$$

where Kᵢ is the normalized image intensity variation at frame i; σ_{i,j,k} is the variance at frame i, pixel indexes j, k defined in Eqn. 3 (below); μ_{i,j,k} is the average at frame i, pixel indexes j, k; μ_{i,j,k} defined in Eqn. 4 (below); Nx is the number pixels in a row; Ny is the number of pixels in a column.

$${μ}_{i , j , k} = \frac{{Σ}_{w = i - [ \frac{Nt}{2} ]}^{i + [ \frac{Nt}{2} ]} {Σ}_{z = j - [ \frac{Ns}{2} ]}^{j + [ \frac{Ns}{2} ]} {Σ}_{y = k - [ \frac{Ns}{2} ]}^{k + [ \frac{Ns}{2} ]} {( {X}_{w , z , y} - {μ}_{i , j , k} )}^{2}}{N C \times N s \times Ns - 1} \qquad ( Eqn . 3 )$$

where X_{w,z,y} denotes a single pixel in frame w; z and y denote the row and column of the pixel within a frame; Nt is the number of frames used; and Ns is the number of pixels of one side of a square window used.

$${σ}_{i , j , k} = \frac{{Σ}_{w = i - [ \frac{Nt}{2} ]}^{i + [ \frac{Nt}{2} ]} {Σ}_{z = j - [ \frac{Ns}{2} ]}^{j + [ \frac{Ns}{2} ]} {Σ}_{y = k - [ \frac{Ns}{2} ]}^{k + [ \frac{Ns}{2} ]} {( {X}_{w , z , y} - {μ}_{i , j , k} )}^{2}}{Nt \times Ns \times Ns - 1} \qquad ( Eqn . 4 )$$

where X_{w,z,y} denotes a single pixel in frame w; z and y denote the row and column of the pixel within a frame; Nt is the number of frames used; and Ns is the number of pixels of one side of a square window used; μ_{i,j,k} is defined in Eqn. 3. As illustrated in FIG. 2C, when the intestine is stationary the image intensity variation is close to 2% and when intestine is moving it increases over 5%. This example demonstrates that intensity variation can be an effective motion artifact indicator.

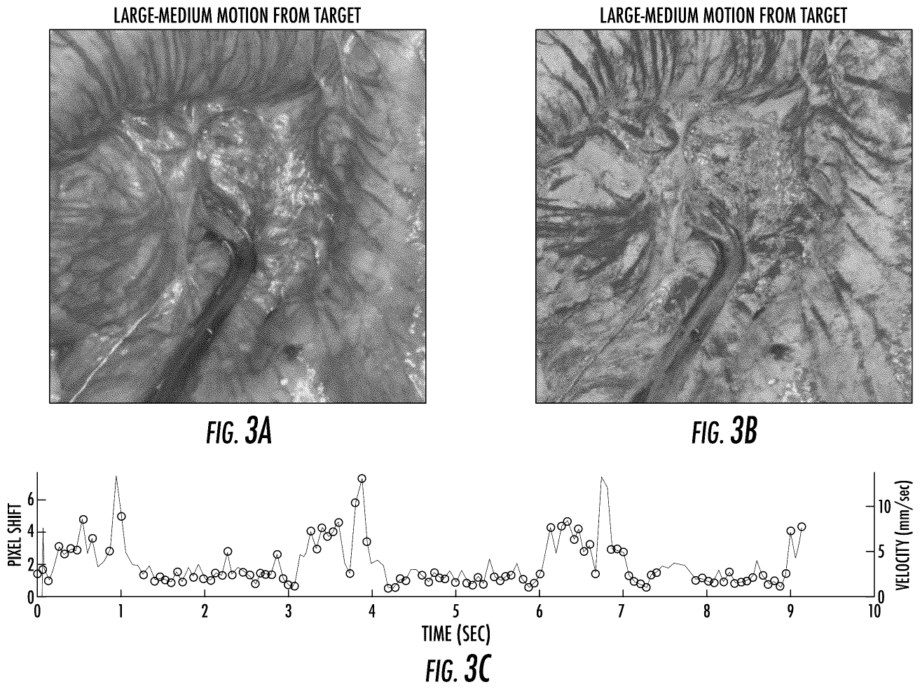

Referring now to FIGS. 3A through 3C, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a segment of porcine intestine with normal blood flow and perfusion and the target continuously moves due to result of ventilation during the image acquisition process. FIGS. 3A and 3B are snapshots of the first frame illustrating temporal and spatially synchronized and aligned visible color image (3A) and blood flow and perfusion map (3B) based on laser speckle contrast. The motion artifact is evaluated and indicated by average pixel shift between frames and converted into velocity unit (mm/s) using imaging parameters such as size of FOV and resolution. The average pixel shift can be calculated using raw visible or NIR images through image registration algorithm or optics flow algorithm. As illustrated in FIG. 3C, when the hand is stationary the pixel shift is 0-1 and when fingers are moving pixel shift increases to >2 pixels between frames.

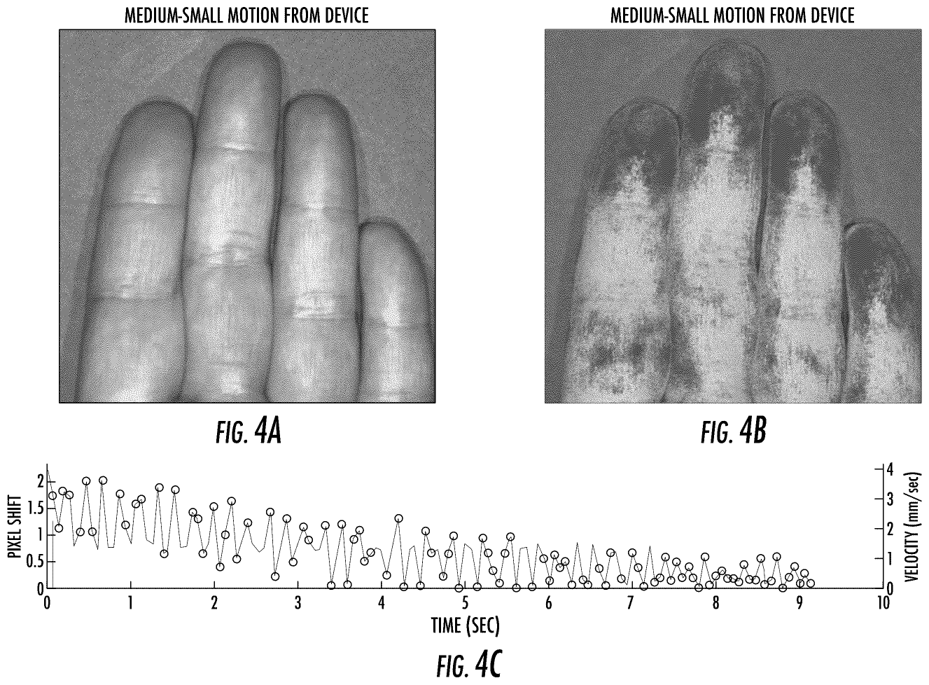

Referring now to FIGS. 4A through 4C, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a human palm with normal blood flow and perfusion and the camera was shaking during the image acquisition process to simulate handheld device motion. FIGS. 4A and 4B are snapshots of the first frame illustrating temporal and spatially synchronized and aligned visible color image and blood flow and perfusion map based on laser speckle contrast. The motion artifact is evaluated and indicated by average pixel shift between frames and converted into velocity unit (mm/sec) using imaging parameters such as size of FOV and resolution. The average pixel shift can be calculated using raw visible or NIR images through image registration algorithm or optics flow algorithm. As illustrated in FIG. 4C, when the hand is stationary the pixel shift is close to zero and when fingers are moving pixel shift increases to >1 pixel between frames.

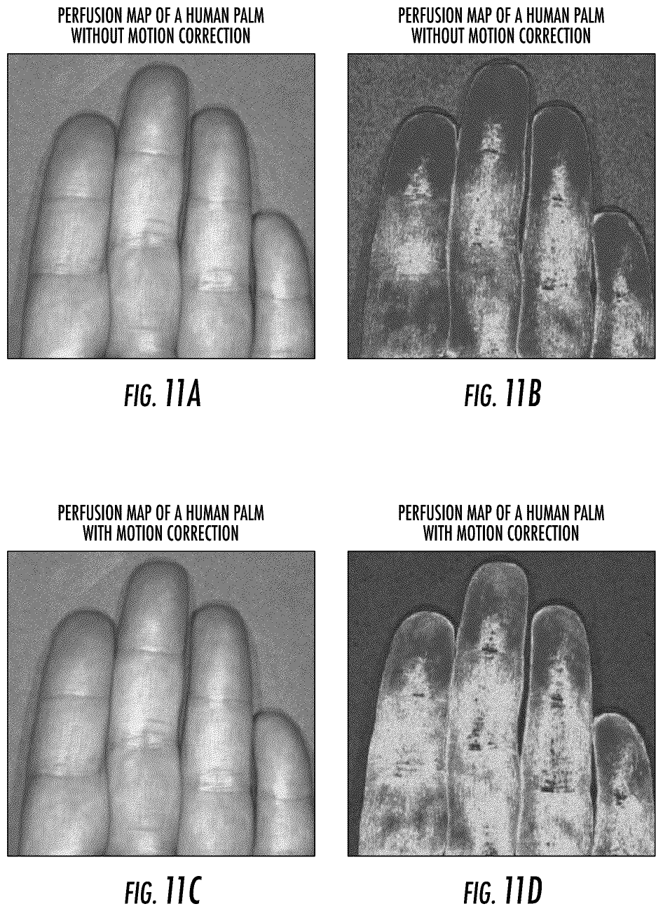

Referring now to FIG. 5, a three-step motion mitigation flowchart is illustrated. Step one 500 avoids large motion by keeping target and device as still as possible under the guide of motion indicator discussed with respect to FIGS. 1A-4C. Hardware sensors such as accelerometer can be an alternative option to indicate device motion artifact. After step one 500 (illustrated by FIGS. 6A-D), only medium and small motion artifacts can enter the imaging system and a motion magnitude threshold needs to be selected and tested to separate large and medium motions. Step two 510 (illustrated by FIGS. 6A-9C) reduces blurriness of the calculated images such as laser speckle contrast by stabilizing frames within a time window. Image stabilization can be achieved through hardware stabilizers such as gimbal motor, liquid lens, or software algorithms such as image registration and alignment. Then a much smaller window (less than one second) in the time series motion indicator signal is identified where average motion magnitude is lowest and then applies blood flow calculation algorithm to the frames within the selected time window. After step two 510, only small motion remains in imaging results that are smaller than one pixel shift. Step three 520 (illustrated by FIGS. 10A-11D) is to fine tune the image quantification results by normalizing perfusion index with either residue motion magnitude or a reference marker. For device translational motion, calibration can be performed to correlation pixel shift with percentage motion noise in the total signal or SNR. Reference markers usually standard diffuse reflection target can be used to estimate baseline noise such as static laser speckle contrast and further removed from the imaging results.

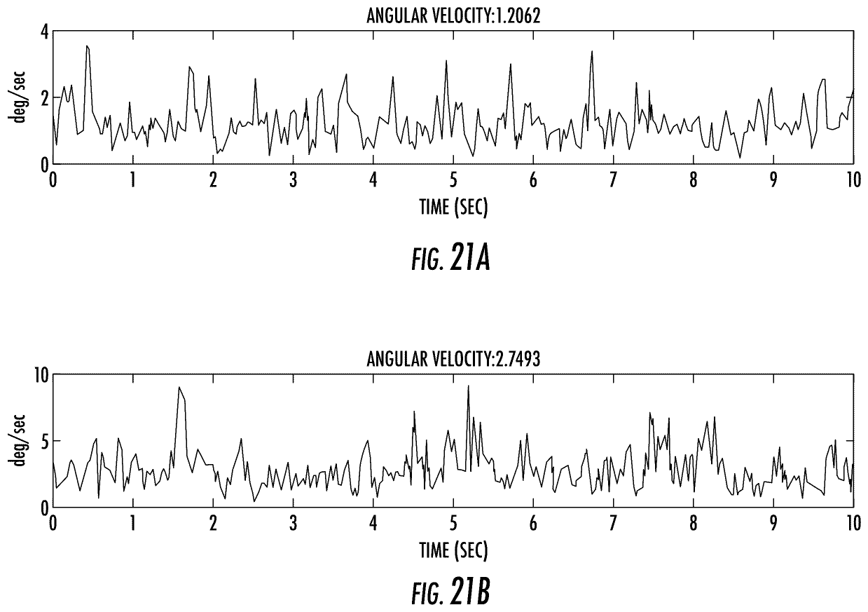

Referring now to FIGS. 21A and 21B, FIG. 21A records motion amplitude during a 10 second time frame when the imaging device is held by operator using both hands stably with x-axis being the time and y-axis being total angular speed in degree/second using a gyroscope as motion sensor. FIG. 21B records motion amplitude during a 10 second time frame when the imaging device is held by operator using one hand unstably with x-axis being the time and y-axis being total angular speed in degree/second using a gyroscope as motion sensor. In summary, when a relative motion artifact between the imaging device and the target object is large (usually >10 degrees/second measured by gyroscope), the impact on LSC includes image distortion and false positive results and a practical solution is to avoid imaging; when relative motion artifact between imaging device and target object is medium (usually 5-10 degrees/second measured by gyroscope), the impact on LSC includes image blurriness and false positive results and a practical solution is to generate a LSC snapshot when motion is minimum; when the relative motion artifact between the imaging device and the target object is small (usually <5 degrees/second measured by gyroscope), the impact on LSC includes inaccurate calculation and a practical solution is to renormalize the LSC based on motion amplitude.

Referring now particularly to FIGS. 6A through 6D, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a segment of porcine intestine with normal blood flow and perfusion and the target continuously moves due to result of ventilation during the image acquisition process. FIGS. 6A and 6B are snapshots of the first frame illustrating temporal and spatially synchronized and aligned visible color image and blood flow and perfusion map based on laser speckle contrast. Two methods to indicate motion magnitude are presented and used to identify a time window where motion artifact is minimum. FIG. 6C illustrates that motion artifacts are evaluated and indicated by average image intensity variation between frames of the visible channel. FIG. 6D illustrates that motion artifacts are evaluated and indicated by average pixel shift between frames of the visible channel. With an appropriately selected threshold, the motion magnitude indicating time signal can be used to guide when image acquisition can be activated in step one of the motion artifact mitigation procedure.

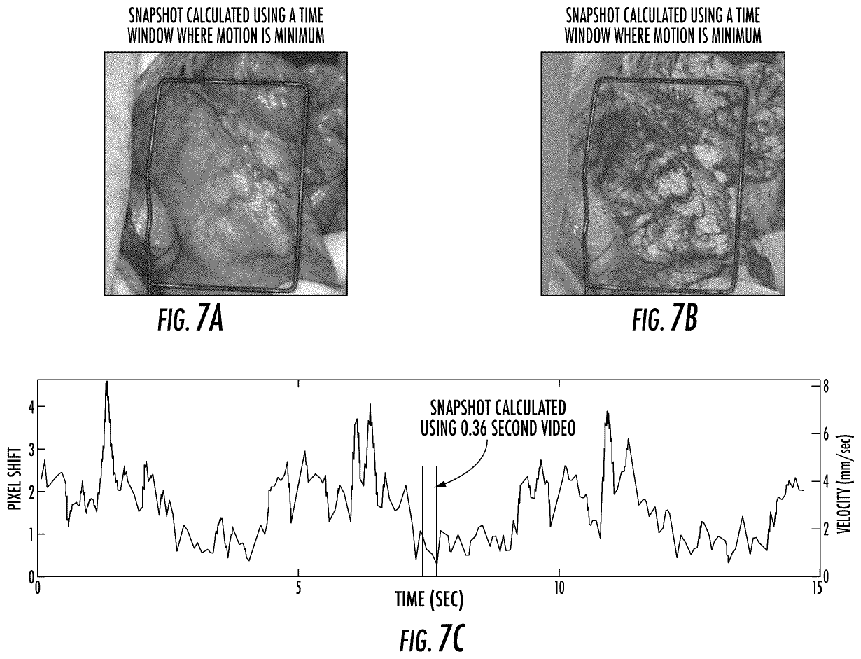

Referring now to FIGS. 7A through 7C, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a segment of porcine intestine with normal blood flow and perfusion and the target continuously moves due to result of ventilation during the image acquisition process. FIG. 7C illustrates that motion artifacts are evaluated and indicated by average pixel shift between frames of the visible channel. A time window (360 ms in this example) is selected where average motion magnitude is minimum. Two vertical lines indicate the time window with minimum motion artifact and frames within this window are used to calculate the top right panel. All image frames within this time window are aligned using center frame as reference through image registration or optics flow algorithms before further image processing based on LSI, LDI or other imaging modality. FIGS. 7A and 7B are snapshots of the perfusion result calculated from frames within the selected window and all frames are temporal and spatially synchronized and aligned before calculating the laser speckle contrast.

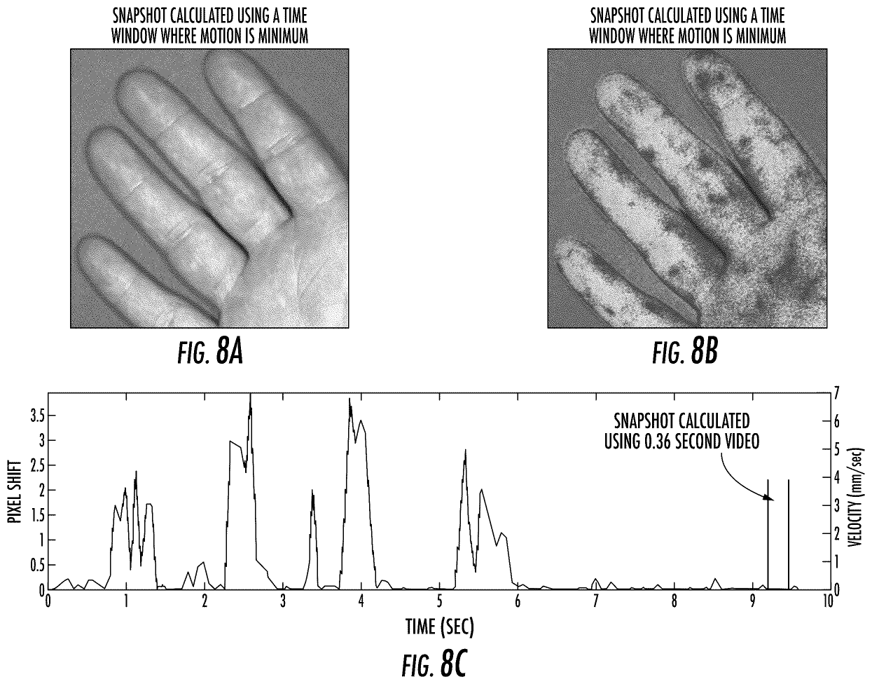

Referring now to FIGS. 8A through 8C, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a human palm with normal blood flow and perfusion and the fingers have been moving during the image acquisition process to simulate accidental target motion artifact. FIG. 8C illustrates that motion artifacts are evaluated and indicated by average pixel shift between frames of the visible channel. A time window (360 ms in this example) is selected where average motion magnitude is minimum. All image frames within this time window are aligned using center frame as reference through image registration or optics flow algorithms before further image processing based on LSI, LDI or other imaging modality. Two red lines indicate the time window with minimum motion artifact and frames within this window are used to calculate the top right panel. FIGS. 8A and 8B are snapshots of the perfusion result calculated from frames within the selected window and all frames are temporal and spatially synchronized and aligned before calculating the laser speckle contrast.

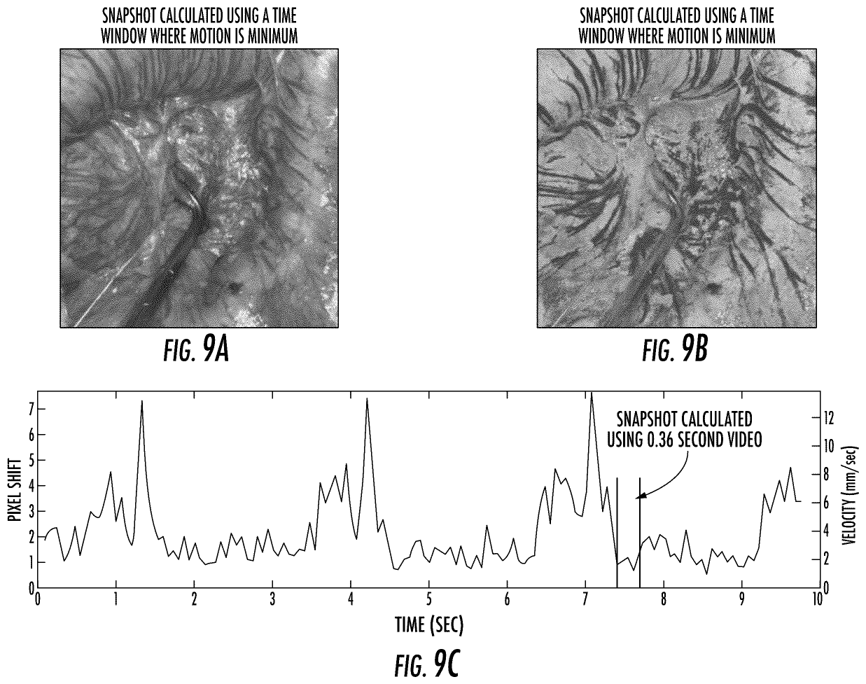

Referring now to FIGS. 9A through 9C, 10 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a segment of porcine small intestine with normal blood flow and perfusion and the target continuously moves due to result of ventilation during the image acquisition process. FIG. 9C illustrates that motion artifacts are evaluated and indicated by average pixel shift between frames of the visible channel. A time window (360 ms in this example) is selected where average motion magnitude is minimum. All image frames within this time window are aligned using center frame as reference through image registration or optics flow algorithms before further image processing based on LSI, LDI or other imaging modality. Two red lines indicate the time window with minimum motion artifact and frames within this window are used to calculate the top right panel. FIGS. 9A and 9B are snapshots of the perfusion result calculated from frames within the selected window and all frames are temporal and spatially synchronized and aligned before calculating the laser speckle contrast.

After step 2 510, there are still residue of motion artifacts left in the calculated result mostly within sub-pixel level. Correction of motion artifacts is critical if imaging results generated at different times need to be compared under the same scale, for example, the perfusion image of a wound bed at before and after certain treatment or different stages of wound healing process. In some embodiments of the present inventive concept to achieve this goal is to statistically estimate the correlation between motion magnitude (for example pixel shift between frames) and SNR or motion artifact component in the signal and then remove the motion artifact from calculated result.

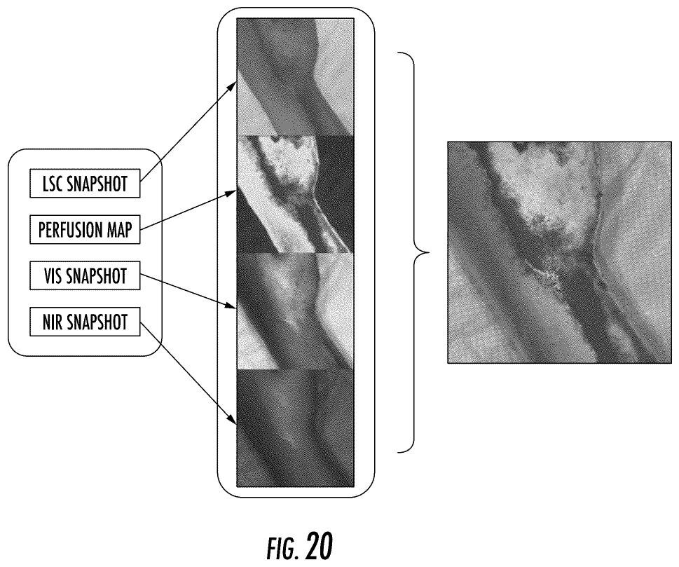

Referring now to FIGS. 10A and 10B, 20 seconds of multispectral images were acquired with visible, non-coherent illumination at 450 nm and coherent NIR laser illumination at 785 nm. A multi-sensor camera was used to capture the reflected light with visible band between 400-700 nm and NIR band 700-900 nm. The visible frame rate is at 30 and NIR is at a higher rate of 160 for LSI analysis. The target is a human palm with normal blood flow and perfusion and the device was shook right before image acquisition and motion artifact continuously to decrease due to damping effect. FIG. 10A illustrates a curve with x-axis being an average pixel shift and y-axis being a percentage of motion noise assuming at the end of the video there is zero motion artifact (dotted plot). A sigmoid function (Eqn. 5, curved plot):

$$y = \frac{a}{1 + {e}^{- x / b}} + c \qquad ( Eqn . 5 )$$

where x is the pixel shift; y is the SNR or motion ratio; and a, b, c are tunable parameters used to estimate the mathematical relation and correct the residue of motion artifact as shown in FIG. 10B where the dotted plot is average perfusion index vs. time curve and as we can see that the perfusion index reduces along the time due to device damping effect. The solid plot is the average perfusion index after the motion artifact correction vs. time curve as we can see that at the end of the video when motion is minimum two plots overlay but at the beginning the corrected perfusion index has less false positive component compared with the uncorrected one. This strategy can be used to achieve step 3 520 in FIG. 5 to improve laser speckle contract calculation accuracy by correlating pixel shift between frames and small motion artifact.

In further embodiments of the present inventive concept, to achieve step 3 520 of motion artifact correction is to use a reflection marker, usually a standard diffuse reflector located in the FOV during imaging. The ROI on the marker will only reflect the result of motion artifact or static baseline in laser speckle imaging modality. In theory, to remove the motion artifact of the target tissue and/or the camera, Galilean velocity addition can be calculated using Eqn. 6.

$${v}_{12} = {v}_{13} + {v}_{32} = {v}_{13} - {v}_{23} \qquad ( Eqn . 6 )$$

where: v₁₃ is the velocity distribution of object of interest (blood flow and perfusion) relative to detector (camera); v₂₃ is the velocity distribution of the host object (the tissue/organ in which the blood vessel is embedded) relative to detector (camera); and v₁₂ is the velocity distribution of an object of interest (blood flow and perfusion) relative to the host object (the tissue/organ in which the blood vessel is embedded). Thus, embodiments of the present inventive concept may address a need to determine v₁₂ under the condition that the image signals by the all the current LSI or LDI method provides only v₁₃. According to some embodiments of the present inventive concept, the multi spectrum imaging approach, both v₁₃ and v₂₃ can be made available.

Using LSI as an example, the speckle contrast of coherent NIR laser light is associated with v₁₃, which is the velocity distribution of an object of interest (blood flow and perfusion) relative to detector (camera). v₁₃ is affected by the movement of blood flow and the movement of tissue caused by factors such as aspiration, spasm, heartbeat etc. and the movement of the camera. Using Eqn. 6, the speckle contrast of reference marker is mainly associated with v₂₃, which is the velocity distribution of the host object (the target tissue that the blood vessel is embedded) relative to detector (camera) assuming uniform motion within FOV. v₁₂ can be derived using v₁₃ and v₂₃ thus the velocity distribution of object of interest (blood flow and perfusion) relative to the host object (the tissue/organ that the blood vessel is embedded) can be quantified without the effect of the movement of tissue/organ and the movement of the camera.

Referring now to FIGS. 11A through 11D, 20 seconds of multispectral images were acquired with visible, non-coherent illumination at 450 nm and coherent NIR laser illumination at 785 nm. A multi-sensor camera was used to capture the reflected light with the visible band between 400-700 nm and NIR band 700-900 nm. The visible frame rate is at 30 and NIR is at a higher rate of 160 for LSI analysis. The target is a human palm with normal blood flow and perfusion and the device was shook right before image acquisition and motion artifact continuously to decrease due to damping effect. FIGS. 11A and 11B are snapshots of the first frame illustrating temporal and spatially synchronized and aligned visible color image (11A) and blood flow and perfusion map (11B) based on laser speckle contrast without motion artifact correction. FIGS. 11C and 11D are snapshots of the first frame illustrating temporal and spatially synchronized and aligned visible color image (11C) and blood flow and perfusion map (11D) based on laser speckle contrast with motion artifact correction based on the invention concepts above. As is clear, there is less false positive perfusion index in FIGS. 11C and 11D and the background has a minimum baseline perfusion after motion artifact correction.

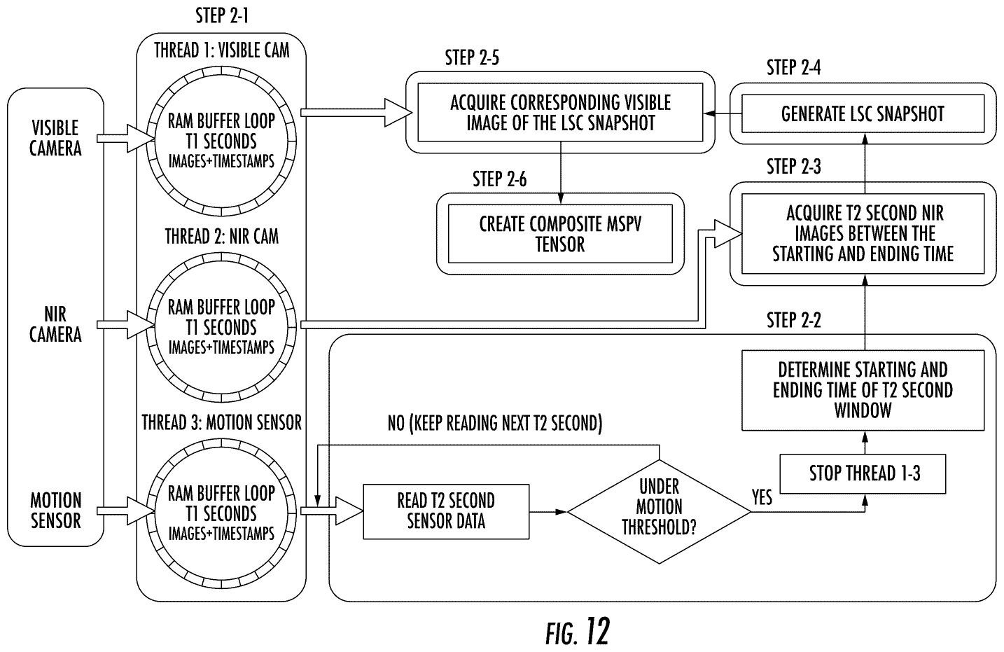

Referring now to FIG. 12, a block diagram illustrates steps 1 and 2 500/510 in FIG. 5 for avoiding large motion and reducing image blurriness. The software algorithm contains 6 sub steps. Step 2-1 illustrates three buffer loops reading and saving data from visible camera, NIR camera and motion sensor in real time. Each FIFO (first in first out) buffer stores T1 second data, and its size is determined by T1 and frame/sampling rate of the camera/sensor. In step 2-2, T2 second data are read out periodically from the end (most recent information) of motion sensor buffer loop and compared with a predefined maximum tolerable motion amplitude threshold. If a certain percentile of the T2 second data are below the threshold, the algorithm will move to the next sub step, otherwise another T2 second will be read out and analyzed after a certain interval. T2 should be smaller than T1 to avoid data rolling out of the buffer during the threshold comparison process. In step 2-3, T2 second NIR images will be temporally synchronized with the motion sensor data in the NIR camera loop buffer and then read out. In step 2-4, T2 second NIR images are used to calculate a laser speckle contrast snapshot. In step 2-5, a visible image will be temporally synchronized with the calculated LSC snapshot in the visible camera loop buffer and then read out. In step 2-6, a composite MSPV tensor is created using visible snapshot, NIR snapshot, LSC snapshot and perfusion map snapshot. The composite MSPV tensor will be used as input for further machine learning based image analysis, display and report. The advantage of this multi-thread FIFO buffer design is to allow dynamic motion monitoring and reduction in real time and therefore save device operational time and improve usability.

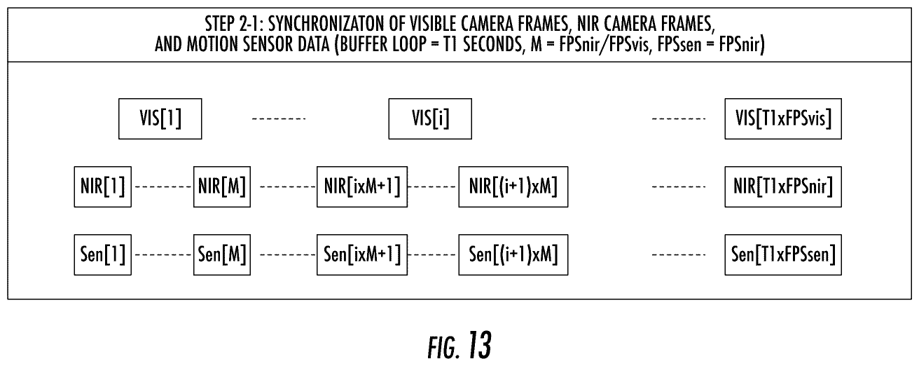

Referring now to FIG. 13, step 2-1 of FIG. 12 is illustrated in detail. Visible camera FIFO buffer loop contains T₁×FPSᵥᵢₛ frames acquired from visible camera, and they are indexed as 1 . . . i . . . T₁×FPSᵥᵢₛ with smaller the index value the earlier the time stamp. NIR camera FIFO buffer loop contains T₁×FPSₙᵢᵣ frames acquired from NIR camera, and since NIR camera has a higher frame rate than visible camera as described previously, each visible frame corresponds to M NIR frames

$$( M = \frac{{FPS}_{nir}}{{FPS}_{vis}} ) .$$

For the same principle, motion sensor data are stored in a FIFO buffer loop and each buffer is managed by a software thread.

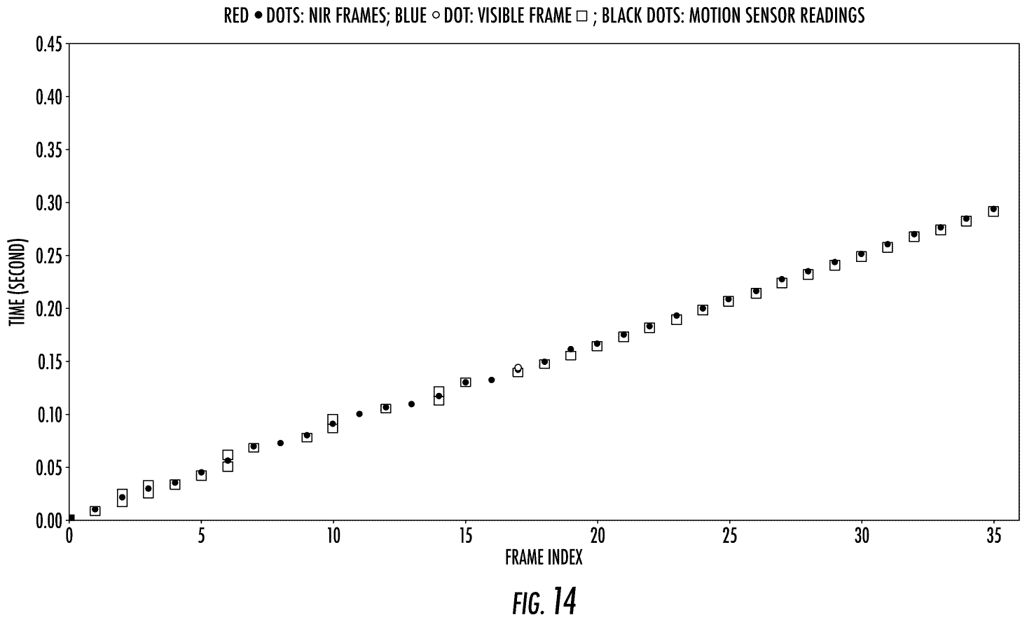

Referring now to FIG. 14, T2 second data are synchronized in the buffer loops, read out and displayed. x-axis is frame index, and y-axis is the time stamp in second. Red dots are frames from NIR camera, blue dot is visible frame, and black boxes are motion sensor data. We can see that the time stamps of different hardware acquisition are overlapped in a straight line which indicates good temporal synchronization. The time stamp of each data acquisition by different hardware can be assigned by the CPU of the computer or embedded system on module (SOM) which controls the peripheral hardware.

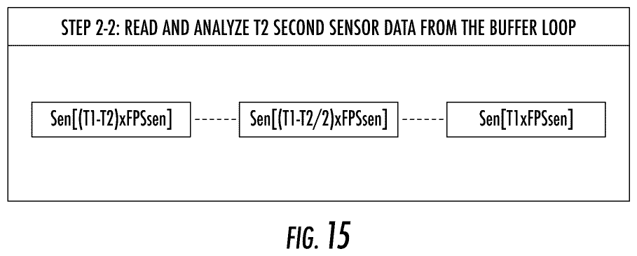

Referring now to FIG. 15, step 2-2 in FIG. 12 is illustrated in detail. T2 second motion sensor data are read out of the loop buffer periodically to examine their amplitude. There are T₂×FPSₛₑₙ samples with FPSₛₑₙ being motion sensor's sampling rate and data are indexed from (T₁−T₂)×FPSₛₑₙ to T₁×FPSₛₑₙ. T2 second at the end of the buffer loop is used because they are the most recent data and if they don't meet the criteria another T2 second data is read out after a certain time interval.

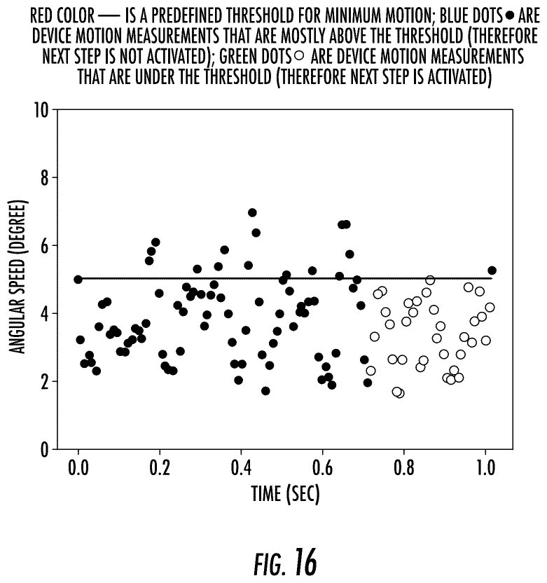

Referring now to FIG. 16, motion sensor data in the buffer loop are compared with a threshold defining maximum tolerable motion amplitude (red line). We can see some data at the beginning of the buffer loop are above the threshold and therefore doesn't meet the criteria (blue dots). Data at the end of the buffer loop are below the threshold and therefore meet the criteria (green dots). In this case, total angular speed is calculated using gyroscope as motion amplitude indicator, and the total buffer length is one second. (T1=1)

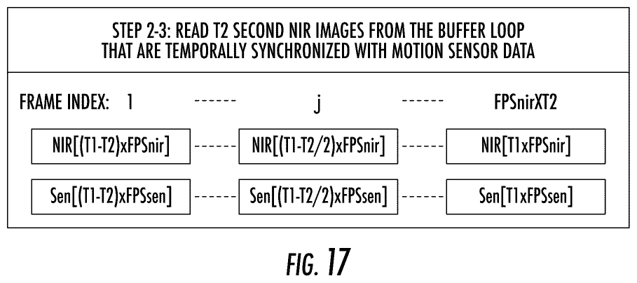

Referring now to FIG. 17, step 2-3 in FIG. 12 is illustrated in detail. Once T2 second motion sensor data meets the criteria, a T2 second of NIR frames in the buffer loop are temporally synchronized with the motion sensor data and read out for LSC calculation. There are T₂×FPSₙᵢᵣ samples with FPSₙᵢᵣ being NIR camera's frame rate and frames are indexed from (T₁−T₂)×FPSₙᵢᵣ to T₁×FPSₙᵢᵣ. For simplicity reason, they are further indexed using 1 to j to T₂×FPSₙᵢᵣ. (j is in the middle of the frames)

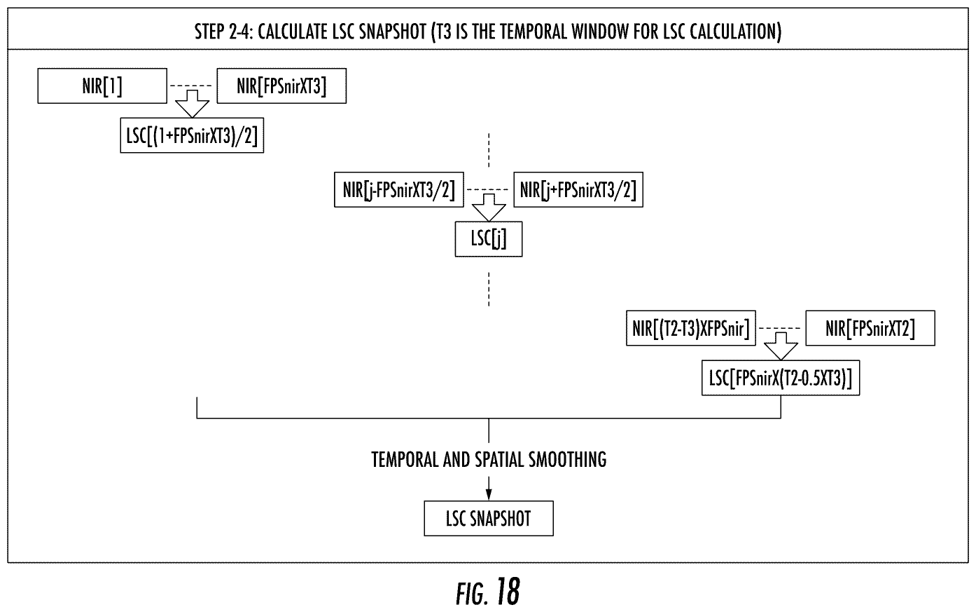

Referring now to FIG. 18, step 2-4 in FIG. 12 is illustrated in detail. The T2 second of NIR frames are used for LSC calculation using temporal, spatial and a combination of algorithms. First, every T3 second of NIR frames (T3<T2) are used to calculate one LSC image and this leads to (T₂−T₃)×FPSₙᵢᵣ LSC images with T3 second LSC calculation core moving every one frame and truncating half of T₃ at beginning and end of T₂ sequence to avoid incomplete calculation. Second, a LSC snapshot is generated by performing temporal and spatial smoothing of the (T₂−T₃)×FPSₙᵢᵣ frames of LSC images.

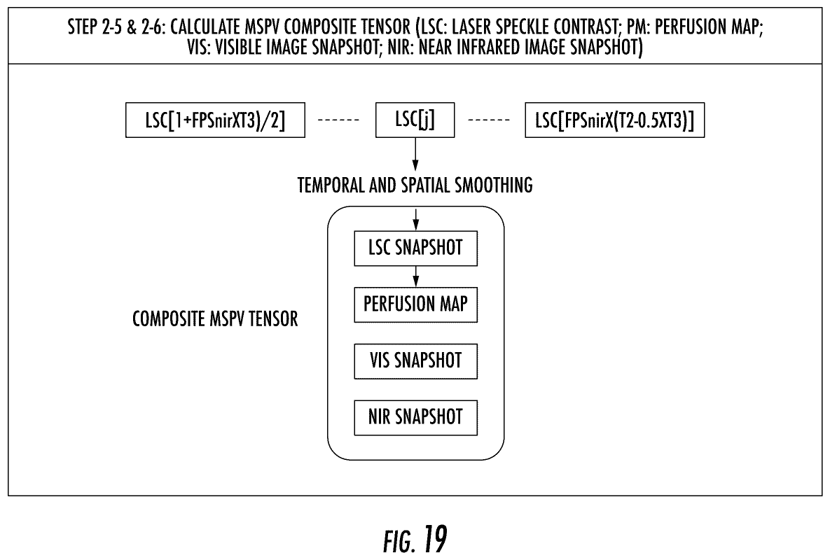

Referring now to FIG. 19, steps 2-5 and 2-6 in FIG. 12 are illustrated in detail. A visible image with the closest time stamp of the LSC snapshot is selected from the buffer loop, and this time stamp corresponds to the middle frame of T2 second. The perfusion map is calculated based on the LSC snapshot. All these snapshots are combined to form a Nx×Ny×N MSPV tensor, and Nx is the resolution of image width, Ny is the resolution of image height, N is the number of channels (in this example N=6). This MSPV composite tensor can be used for further image analysis, machine learning training and prediction input, and further multi-layer visualization.

Referring now to FIG. 20, components in the composite MSPV tensor are further illustrated. LSC snapshot is a Nx×Ny tensor with value ranging from 0 to 1 and corresponding to the gray color picture on the top. Perfusion map is a Nx×Ny tensor with value ranging from 0 to 1 after normalization corresponding to the color map on the second row (blue: low flow; yellow: medium flow; red: high flow). Visible snapshot is a Nx×Ny×3 RGB tensor with value ranging from 0 to 255 (image on the third row) and NIR snapshot is a mono Nx×Ny tensor with value ranging from 0 to 255 (image on the bottom). For example, the MSPV composite tensor can be used to generate a multi-layer perfusion map as shown on the right panel.

Some embodiments of the present inventive concept provide a device and target motion monitoring and quantification design used as an add on component to a multispectral soft tissue imaging system. The multispectral illumination design emits light of N different bands or ranges of wavelengths from 300 nm to 1000 nm. The multispectral sensing design images reflected/emission light of N different bands or ranges of wavelengths from 300 nm to 1000 nm. The imaging modalities may include a Laser Speckle Imaging algorithm that can calculate perfusion map using NIR imaging channel or an Oxygen Saturation Imaging algorithm that can calculate peripheral arterial oxygen saturation map using visible and NIR imaging channels.

Further embodiments of the present inventive concept provide a device and target motion monitoring and quantification design based on a hardware accelerometer or gyroscope signal.

Still further embodiments provide a device and target motion monitoring and quantification design based on image alignment signal such as pixel shift between frames.

Some embodiments provide a device and target motion monitoring and quantification design that can be based on image intensity variation between frames defined in Eqns. 2-4 discussed above.

Further embodiments of the present inventive concept provide an image acquisition triggering design to avoid imaging when motion artifact is above a threshold in the motion indicator.

In still further embodiments, a snapshot calculation design may be used to evaluate motion artifact during image acquisition and select a time window with minimum motion artifact to calculate result for the following imaging modalities: a Laser Speckle Imaging algorithm that can calculate perfusion map using NIR imaging channel; an Oxygen Saturation Imaging algorithm that can calculate peripheral arterial oxygen saturation map using visible and NIR imaging channels.

In some embodiments a motion artifact assessment design may be provided to correlate pixel shift with SNR based on Eqn. 5 for these imaging modalities.

In further embodiments, a motion artifact correction design may be provided using a reflection marker based on Eqn. 6.

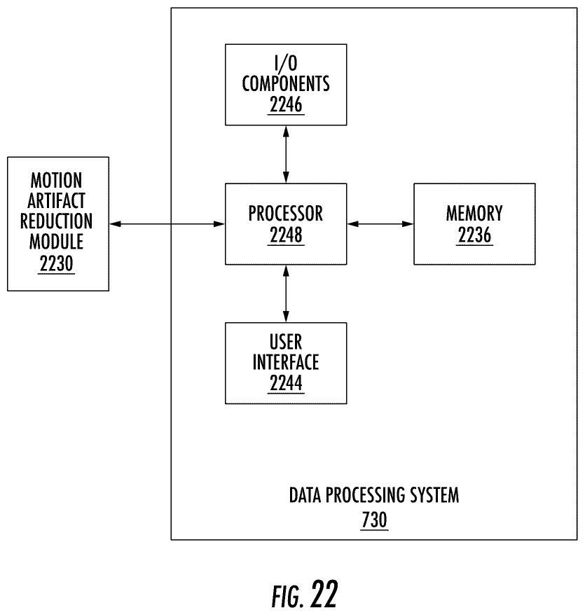

Referring now to FIG. 22, an example of a data processing system 730 suitable for use with any of the examples described above. Although the example data processing system 730 is shown as in communication with the motion artifact reduction module 2230 in accordance with embodiments of the present inventive concept, the data processing system 730 may also be part of the routing module 2295 or in any other component of the system without departing from the scope of the present inventive concept. In some examples, the data processing system 730 can be any suitable computing device for performing operations according to the embodiments discussed herein described herein.

As illustrated, the data processing system 730 includes a processor 2248 communicatively coupled to I/O components 2246, a user interface 2244 and a memory 2236. The processor 2248 can include one or more commercially available processors, embedded processors, secure processors, microprocessors, dual microprocessors, multi-core processors, other multi-processor architectures, another suitable processing device, or any combination of these. The memory 2236, which can be any suitable tangible (and non-transitory) computer-readable medium such as random-access memory (RAM), read-only memory (ROM), erasable and electronically programmable read-only memory (EEPROMs), or the like, embodies program components that configure operation of the data processing system 730.

I/O components 2246 may be used to facilitate wired or wireless connections to devices such as one or more displays, game controllers, keyboards, mice, joysticks, cameras, buttons, speakers, microphones and/or other hardware used to input or output data. Memory 2236 represents nonvolatile storage such as magnetic, optical, or other storage media included in the data processing system and/or coupled to processor 2248.

The user interface 2244 may include, for example, a keyboard, keypad, touchpad, voice activation circuit, display or the like and the processor 2248 may execute program code or instructions stored in memory 2236.

It should be appreciated that data processing system 730 may also include additional processors, additional storage, and a computer-readable medium (not shown). The processor(s) 2248 may execute additional computer-executable program instructions stored in memory 2236. Such processors may include a microprocessor, digital signal processor, application-specific integrated circuit, field programmable gate arrays, programmable interrupt controllers, programmable logic devices, programmable read-only memories, electronically programmable read-only memories, or other similar device.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random-access memory (SRAM), dynamic random-access memory (DRAM), or magnetic random-access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

In the specification, there have been disclosed embodiments of the inventive concept and, although specific terms are used, they are used in a generic and descriptive sense only and not for purposes of limitation. The following claim is provided to ensure that the present application meets all statutory requirements as a priority application in all jurisdictions and shall be construed as setting forth the scope of the present inventive concept.

What is claimed is:

1. A multispectral imaging system that synchronizes multiple cameras and sensors in real time, the system comprising:
a first light source to generate a visible wavelength light;
a second light source to generate near infrared (NIR) wavelength light;
a first image sensor to detect visible wavelength light;
a second image sensor to detect near infrared wavelength light;
a first motion sensor to detect acceleration of the imaging system;
a second motion sensor to detect angular speed of the imaging system; and
a storage module that buffers and synchronize multiple threads of acquired data in real time.

2. The system of claim 1, where the storage module comprises a first in first out (FIFO) loop buffer to store acquired data from each hardware source.

3. The system of claim 1, where the storage module uses parallel threads to manage all FIFO loop buffers.

4. The system of claim 1, where the storage module uses a hardware clock as a reference to synchronize all data streams.

5. system of claim 4, wherein the hardware clock is a CPU time stamp used as reference to synchronize all data streams.

6. A laser speckle imaging system that increases a signal to noise ratio of a laser speckle contrast calculation, the system comprising:
a monitoring module that monitors a relative motion artifact between an imaging device and a target object and triggers laser speckle image acquisition when the motion artifact is under a maximum tolerable threshold to reduce large motion artifacts;
an acquisition module that acquires a sequence of laser speckle images with a minimum motion artifact and generates one laser speckle contrast snapshot to reduce medium motion artifact; and
an analysis module that analyzes and remove the residue motion in the LSC snapshot to fine tune the minimum motion artifact.

7. The system of claim 6, where device motion is estimated using signals from the motion sensor.

8. system of claim 7, wherein the motion sensor comprises accelerometer or gyroscope.

9. The system of claim 6, wherein relative motion between the device and the target is estimated through image registration resulting from a sequence of image frames acquired by an NIR camera and wherein the relative motion being caused by at least one of pixel shift, frame interval and pixel size.

10. The system of claim 9, wherein relative motion is calculated using the following equation:
$$v ( i , j ) = \frac{pixel shift ( i , j ) \times pixel size}{1 / FPS}$$
wherein v is speed of target or tissue motion at pixel index i, j between frames; and frames per second (FPS) is the frame rate.

11. The system of claim 6, wherein relative motion between the device and the target is estimated by calculating intensity average and variation of each pixel within a time interval.

12. The system of claim 11, wherein average image intensity variation is calculated using the following equation:
$${K}_{i} = {Σ}_{k}^{N y} {Σ}_{j = 1}^{N x} {σ}_{i , j , k} / {μ}_{i , j , k}$$
wherein Kᵢ is a normalized image intensity variation at frame i; σ_{i,j,k} is the variance at frame i, pixel indexes j, k; μ_{i,j,k} is the average at frame i, pixel indexes j, k; μ_{i,j,k}; Nx is the number pixels in a row; Ny is the number of pixels in a column;
wherein:
$${μ}_{i , j , k} = \frac{{Σ}_{w = i - [ \frac{Nt}{2} ]}^{i + [ \frac{Nt}{2} ]} {Σ}_{z = j - [ \frac{Ns}{2} ]}^{j + [ \frac{Ns}{2} ]} {Σ}_{y = k - [ \frac{Ns}{2} ]}^{k + [ \frac{Ns}{2} ]} {( {X}_{w , z , y} - {μ}_{i , j , k} )}^{2}}{N C \times N s \times Ns - 1}$$
wherein X_{w,z,y} denotes a single pixel in frame w; z and y denote the row and column of the pixel within a frame; Nt is the number of frames used; and Ns is the number of pixels of one side of a square window used; and
$${σ}_{i , j , k} = \frac{{Σ}_{w = i - [ \frac{Nt}{2} ]}^{i + [ \frac{Nt}{2} ]} {Σ}_{z = j - [ \frac{Ns}{2} ]}^{j + [ \frac{Ns}{2} ]} {Σ}_{y = k - [ \frac{Ns}{2} ]}^{k + [ \frac{Ns}{2} ]} {( {X}_{w , z , y} - {μ}_{i , j , k} )}^{2}}{Nt \times Ns \times Ns - 1}$$
wherein X_{w,z,y} denotes a single pixel in frame w; z and y denote the row and column of the pixel within a frame; Nt is the number of frames used; and Ns is the number of pixels of one side of a square window used; μ_{i,j,k}.

13. The system of claim 6, wherein residue motion is estimated by correlating pixel shift with SNR.

14. The system of claim 6, wherein residue motion is removed by using a reflection marker.
